(19) United States
(12) Patent Application Publication
(10) Pub. No.: US 2014/0095279 A1
(43) Pub. Date: Apr. 3, 2014

(54) Web-based Marketing Method

(71) Applicant: David Everett Benge Ward, Yacolt, WA (US)

(72) Inventor: David Everett Benge Ward, Yacolt, WA (US)

(21) Appl. No.: 13/789,470

(22) Filed: Mar. 7, 2013

Related U.S. Application Data
(63) Continuation-in-part of application No. 12/291,748, filed on Nov. 12, 2008.

(51) Int. Cl. G06Q 30/02

(52) U.S. Cl. CPC G06Q 30/0209
USPC 705/14.12

(57) ABSTRACT

An Internet marketing venue focused around a Web-based casual game. The game is an entertainment site designed for simplicity of play with low commitment. Sponsors provide prizes and rewards, which are made available to the highest-scoring players. These winners select the prizes they most prefer, while non-winners earn points to be “spent” on rewards they choose. In this way, sponsors are connected to customers with both a proven interest and emotional investment in their products.

### CROSS-REFERENCE TO RELATED APPLICATIONS

This application is a continuation-in-part of U.S. patent application Ser. No. 12/291,748 filed Nov. 11, 2008 entitled Web-based Marketing Method, and claims the benefit of provisional application No. 60/018,971 filed Jan. 4, 2008, these applications being incorporated herein by reference.

### BACKGROUND

The Internet has become a major contributor in the fields of entertainment and new customer acquisition. The disclosed method was created to combine these two dynamic elements in a new and unique manner that both provides enhanced entertainment to the player and enhanced value to the sponsor.

Entertainment on the Internet is growing dramatically, with new games being made available on a weekly, if not daily, basis. The area of casual gaming has seen particular growth, and is expected by The Casual Games Association to reach over $2 billion this year and will continue to grow at about 20% annually. The demographic often cited as the fastest growing is married women and people over 35, which is a principal demographic for many advertisers and sponsors. Internet users are often seeking a diversion that offers both entertainment and information, and provides both with a minimal investment of time and minimal commitment.

Advertisers and sponsors compete on the Internet for new customers using increasingly sophisticated methods. Traditional banner-type advertisements are making way for contextual advertisements, product placement, and multimedia-type ads that invade the content of the Web site and demand attention. The advent of social media marketing and mobile platform devices is having a dynamic effect upon the on-line advertising landscape. The goal for many advertisers is to do more than just garner a casual click from a random Web site visitor. In order to maximize the return for the advertising dollars spent, advertisers attempt to acquire customers that are both demographically suitable to their products and services, as well as having a proved interest in them.

### SUMMARY

In the subject invention, casual games are offered by creating a Web page available at no cost to consumers who use personal computers or mobile platform devices for access. Advertisers are invited to offer their wares as prizes and rewards to players of the game. Players who are successful enough at the games, playing as individuals or team members to earn a prize or reward, may then select which of the offered products for which they are eligible they prefer as their prize.

This method has two desirable effects. First, by enticing consumers to earn prizes and rewards, rather than simply mailing coupons to them or offering giveaways, the game fosters a sense of value akin to that fostered when actual money is spent; the prizes and rewards are not mere throwaways. Second, by allowing consumers to choose which prize they prefer, the opportunity to choose which prize or reward they prefer, the advertiser can be sure that the offered good or service is actually useful to and desired by the consumer, and can avoid the wasted expense of, for example, soliciting married consumers for dating services or male consumers for makeup promotions.

The claimed method overcomes some of the shortcomings of the prior art by offering a novel means for connecting advertisers through social media with customers who are interested in their products.

The foregoing and other objectives, features, and advantages of the method will be more readily understood upon consideration of the following detailed description taken in conjunction with the accompanying drawings.

### BRIEF DESCRIPTION OF THE SEVERAL DRAWINGS

FIG. 1: Overall system block diagram of a preferred embodiment.

FIG. 2: Block diagram showing process flow of player registration.

FIG. 3: Block diagram showing the process flow of the Web site Points Distribution System.

FIG. 4: Block diagram of information flow of prediction game event creation.

FIG. 5: Block diagram of flow of Prediction game play.

FIG. 6: Block diagram process flow of player answering questions.

FIG. 7: Block diagram of information flow of Trivia game creation.

FIG. 8: Block diagram of process flow of players participating in Trivia.

FIG. 9: Block diagram of process flow of Blackjack points play.

FIG. 10: Block diagram of process flow of Solitaire points play.

FIG. 11: Block diagram of process flow Texas Hold'em points play of the prize drawing system.

FIG. 12: Block diagram of flow showing how teams are formed and compete to win prizes.

FIG. 13: Block diagram showing the process flow for the monthly/quarterly Prize Drawing.

FIG. 14: Block diagram of process flow of prize award bid system.

FIG. 15: Block diagram of flow or prize sponsor participation.

FIG. 16: Block diagram of flow of reward sponsor participation.

FIG. 17: Block diagram showing process flow of rewards redemption.

FIG. 18: Block diagram showing flow of corporate non-profit sponsorship.

FIG. 19: Block diagram of flow of auction event sponsorship.

FIG. 20: Block diagram of flow of player participation in a real-time auction event.

FIG. 21: Block diagram of flow of player participation in a silent auction event.

FIG. 22: Block diagram of flow showing how players win prizes with points in the League and Team competition.

FIG. 23: Block diagram of process flow showing how a player participates in the card race ladder board competition.

FIG. 24: Block diagram showing how a player participates in the Texas Hold'em ladder board competition.

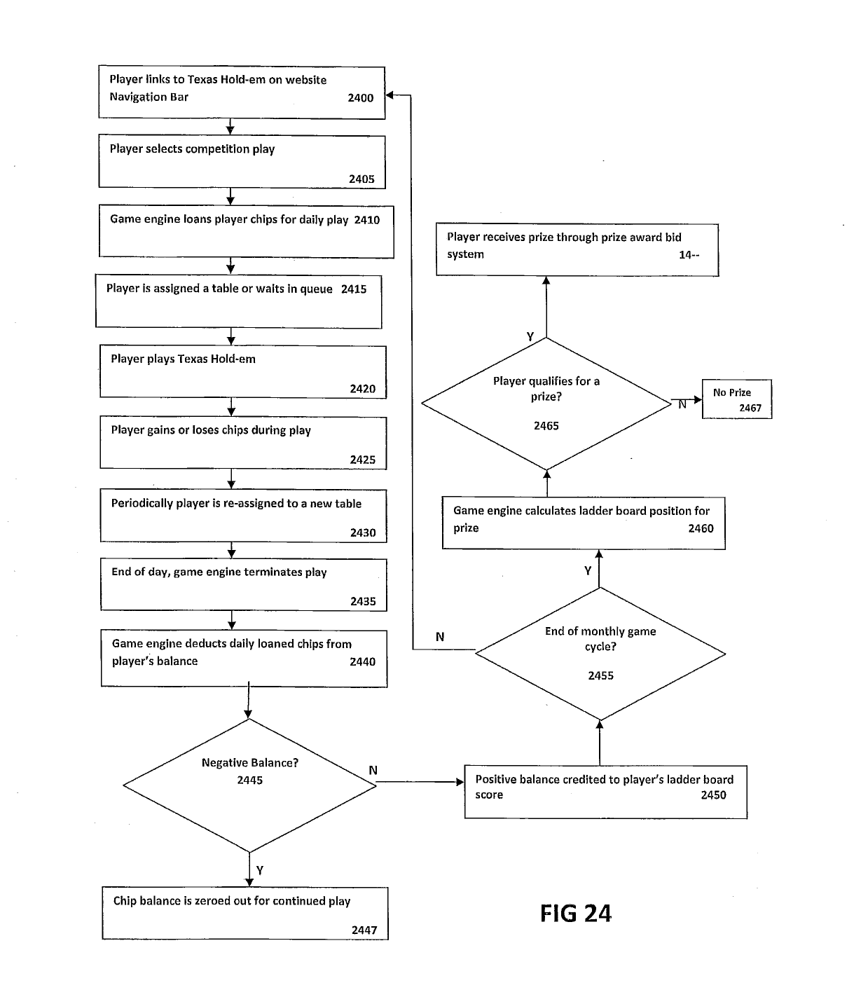

### DETAILED DESCRIPTION OF PREFERRED EMBODIMENTS

The subject method provides a relationship between a customer and the business for an extended period of time through the mechanism of ongoing Web-based games where the business' product or service can be offered as a prize and/or a reward, associated with sponsor advertisements on the Web site. A customer, or more accurately player, earns points for correctly predicting the outcome of future events, answers to daily trivia questions as well as compensation for participation in card, board and other casual on-line games. These points are distributed and accumulate over time in four distinct points accounts. Points are concurrently deposited in more than one account depending upon which game activity is played.

For certain card games, player chips can also be earned for team and individual prizes. Virtual chips are used as tools to play the Web site card games. Positive play chip balances allow players to compete for prize incentives simultaneously as individuals and as members of a card race team.

Points in a player's monthly/quarterly prize drawing account are automatically converted to drawing tickets at a predetermined point's accumulation level. Excess points in the account are rolled over into the following month and quarter. At the end of the calendar month and quarter, a computer-generated random drawing is conducted with the number of tickets drawn matching the number of sponsored prizes offered for each drawing. Players with winning tickets are notified by e-mail of the sequence in which their ticket was drawn. The winners of a round then enter a bidding process where they select their prizes in the order of the sequence their ticket was drawn. Prize tickets remain valid until the end of the calendar quarter even if a winning monthly drawing ticket was drawn. At the end of the quarter, all tickets are liquidated.

Points in a player's Rewards account can be redeemed for a tangible reward offered by an advertiser/sponsor from a list of competing offers. Individual rewards are offered at a specified valuation that translates into a points redemption cost for the player when redeemed. Rewards points do not expire as long as the player remains active on the Web site as a registered player.

If a player is also a registered member of a Web site team, for certain games the player's earned points contribute to the team's aggregate point total. Teams compete for advertiser/sponsor supplied prizes on a month-to-month basis. Competitions are within geographically defined leagues and between leagues for overall team winner and placements and for winner and designated placement positions within each league.

The Web site will periodically conduct real time and silent auction bid events, silent auction events or a combination of both for the purpose of infusing a dynamic element into the Web site's marketing campaign and to provide a promotion campaign platform for retailers to introduce new products and liquidate excess inventories and obsolescent products. Auction Bid Points combined with player committed Rewards points are used by the players to bid on auction items.

Corporations will have the opportunity to promote their sponsors non-profit charities by matching cash donations with players' offered reward points.

The results of a player's chip balances for play of specific Web site card games are tabulated and recalculated daily and then factored into team and individual play ladder board competitions. Team competitions run month-to-month and are depicted and conducted as races within geographical defined leagues. Individual competitions for top performers run concurrently with the team competitions plus an extra week. Advertiser/sponsors supply prizes for each team and individual race winners and for designated race placements positions.

Three elements make this method unique and valuable to businesses offering their products and services as prizes and rewards. First, the player accumulates points over time, so the prize or reward is visible to the player over an extended period of time, allowing the business time to present the player with additional information and exposure. Second, the player has to earn the points, and so has the vesting in the points that gives them an intrinsic value—points hard-earned are not to be spent lightly. Third, this intrinsic value in the points is transferred into the prize or reward by the nature of this prize or reward being chosen by the player from a selection. Prizes and rewards are both earned, and chosen, which establishes a relationship between the player and business that would not otherwise exist.

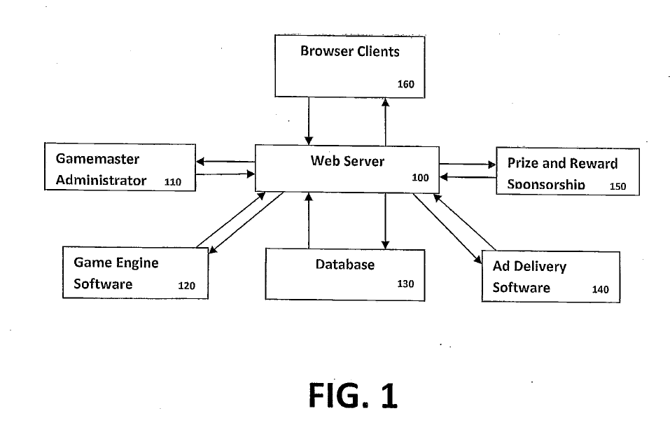

FIG. 1 is an overall block diagram of a preferred embodiment of the present method. In this embodiment, a Web server 100 is a cloud-computing server system and the associated networking hardware, as well as various server software programs. This aggregate Web server 100 is the focal point for all interaction of the other components, accepting input from and generating output to the other components via a network, for example, a local area network. The game master/administrator component 110 is a control component which accesses various elements of the game engine 120, database 130, ad delivery software 140, or prize and reward redemption sponsorships 150. The game engine 120 is a software component that executes on a server computer and provides the Web server 100 with information to present to a browser client 160, as well as executing various periodic and cyclic functions that operate the game. The database 130 is a software component that operates on a server computer and is the central repository of data including, but not limited to, player information such as user names, passwords, and preferences, game information such as questions and answers, advertising data, prize and reward data, control data, and all manner of data required for the computer system to function. The ad delivery software 140 is a software component that executes on a server computer and incorporates various types of advertisements into the output the Web server 100 provides for the browser client 160. Prize and reward sponsorships 150 are business components that are represented in the method as elements of the game presented to the Web server 100 and presented to the browser client 160. The browser client 160 is a standard software program that runs on a personal computer or mobile communication platform and is used to view Web sites on the Internet, for example, Internet Explorer or Firefox.

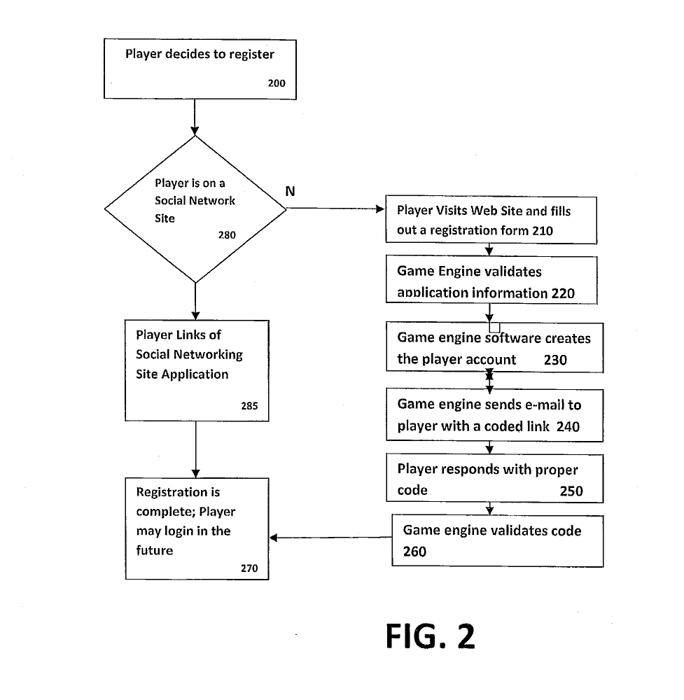

FIG. 2 is a block diagram showing how a new player registers with the game. A player visits the Web site and chooses to register 200. The player fills out a simple form 210 in their browser client which is validated by the game engine software 220. If the information provided by the player is suitable, the game engine software creates a player account 230, and the game engine logs the player in for a single session. The game engine software sends the player an e-mail 240 with a special, coded confirmation link, then waits for the player to click on the link in the future 250. If the game engine software receives the appropriate code as the result of the user clicking the link 260, the game engine software completes the registration 270 and the player is allowed to login in the future. Alternately, players can access the Web site through the Web site application 280 from a participating social network site and be automatically registered.

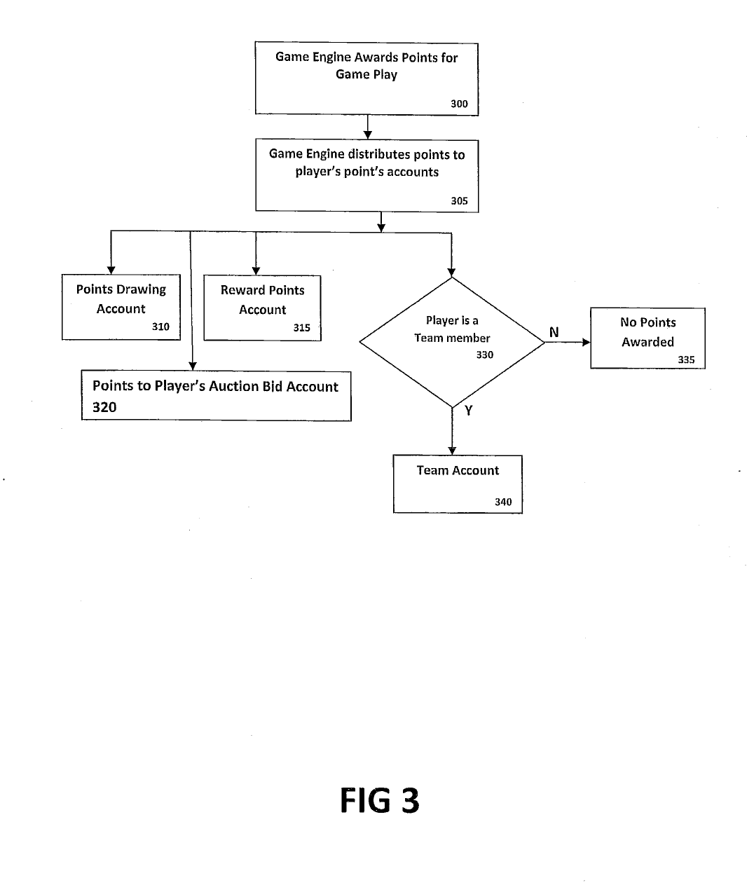

FIG. 3 is a block diagram showing the process flow of the Web site Points Distribution System. The player plays various games on the Web site and is awarded points for participation and quality of play 300. Based upon which game is played, the game engine determines how the points are distributed 305. As an example, points earned in the Prediction and Trivia games accrue concurrently to a player's points drawing account 310, their rewards redemption account 315, their auction bid account 320 and if a member of a team 330, their team's account 340. Similarly if a player earns points playing Blackjack, Solitaire or similar card games, their game points only accrue to their points drawing account 310, their rewards redemption account 315 and their auction bid account 330.

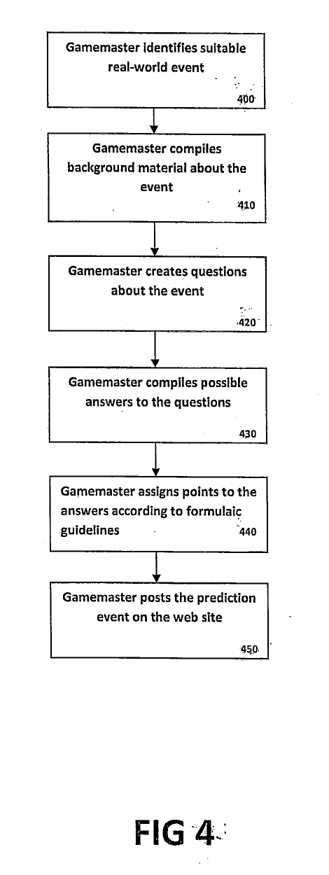

FIG. 4 is a block diagram showing how a game master creates an event to be added to the prediction game. The game master chooses a suitable real world event 400. This event preferably has a definitive outcome that is in question, is likely to occur within a reasonable period of time, is of interest to a cross-section of the game players, and preferably is not controversial or adult in nature. The game master then does sufficient research on the event 410 to provide the players with an adequate description as well as possible encyclopedic entries on the site. The game master then takes this reference material and creates one or more questions about the event 420 that can have definitive answers. These answers are compiled 430 and checked for completeness so that every reasonable real world outcome is reflected in the answer choices. The answer choices may be single, multiple or ordered. The game master assigns points to the answers 440 in a subjective manner that nevertheless follows some guidelines. First, the societal significance plays a large part in the overall number of points that can be earned for a question. Second, the more questions there are in a given event, the fewer points can be earned for each question. Third, the more correct answers there might be for a particular question, the fewer points each of those answers are worth. Conversely, ordered answers might be assigned higher points because of the greater complexity of determining a correct order. Fourth, the farther in the future the event should finalize, the more points that can be earned for that question. Fifth, the less likely a particular answer is relative to the other answers in a question in the opinion of the game master, the more points that answer is worth relative to the others. Once points are assigned, the game master posts the event on the Web site 450, and the event is made available to players.

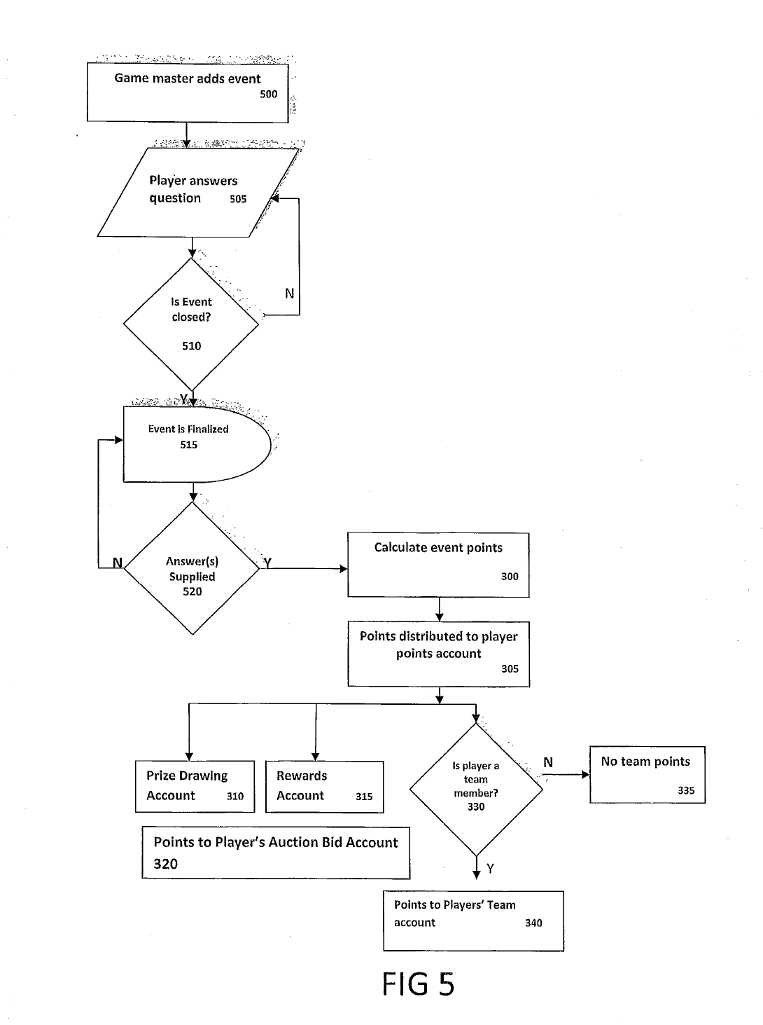

FIG. 5 is a block diagram showing how the prediction game operates. The game runs continuously 500 with the game master adding new events 510 in such a manner that there are usually several but at least one open event question offered for players to answer at any one time. Players regularly visit the site and answer questions for these events 520 in their browser client, provided the events are open for answering. When an event is closed 530, the players can no longer answer questions and the game engine waits until the event is finalized 540 and the correct answers are supplied by the game master 550. When the correct answers are supplied by the game master, the game engine calculates each player's points 560. Points are then distributed to the player's points accounts 305: the prize drawing account 310, the rewards redemption account 315, the auction bid account 320 and if the player is a member of a team 330, to the player's team account 340.

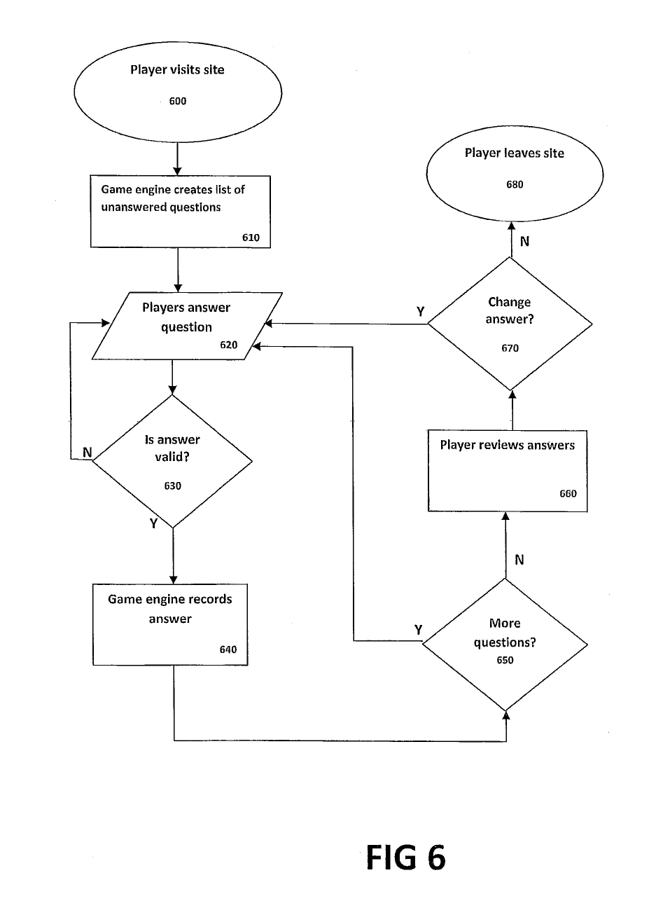

FIG. 6 is a block diagram showing how players participate in the prediction game by answering questions. When a player visits the Web site 600 the game engine creates a list of questions the player has not answered 610. The player may have the opportunity to answer all the questions 620, or may be limited to a predetermined number of questions per visit. For each question the player answers the game engine validates the answer 630 for a variety of factors, and if the answer is valid, the game engine records the answer 640. Once there are no more questions to answer, or the player chooses to stop answering questions, 650 the player may be presented with a review of the recorded answers 660 and the opportunity to change those answers 670. Until an event is closed, previously answered questions can be reviewed 660 and changed 670 as well. Finally, the player leaves the Web site 680.

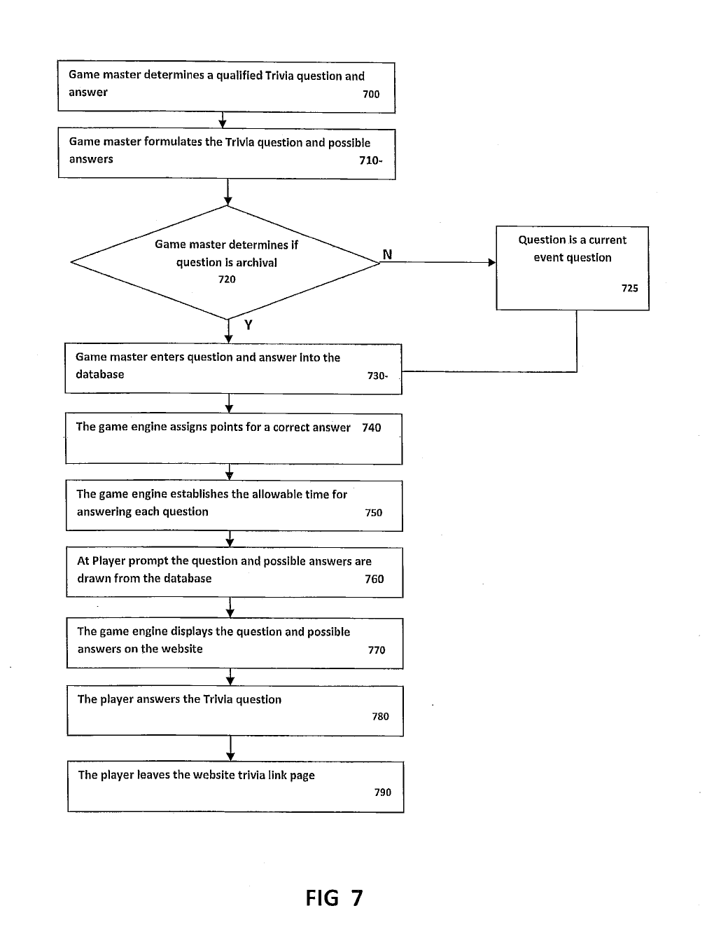

FIG. 7 is a block diagram showing process flow of how the Trivia game operates. The game master determines a qualified trivia question and appropriate answer 700. The game master formulates the trivia question and answer choices including the correct answer with an explanation 710. The game master determines whether the trivia question is appropriately an archive 720 question or a current events 725 question. The Game master enters the question and correct answer into the data base 730. The game engine assigns a predetermined number of points 740 and a restricted period of time 750 for correctly answering the question dependent upon the category. Current event questions are assigned lower points than archived questions and will expire automatically in the data base after a predetermined duration. At player prompt the questions and answers are drawn from the data base 760 and displayed on the Web site trivia link page 770. The player answers the questions 780 and leaves the Web site Trivia link page 790.

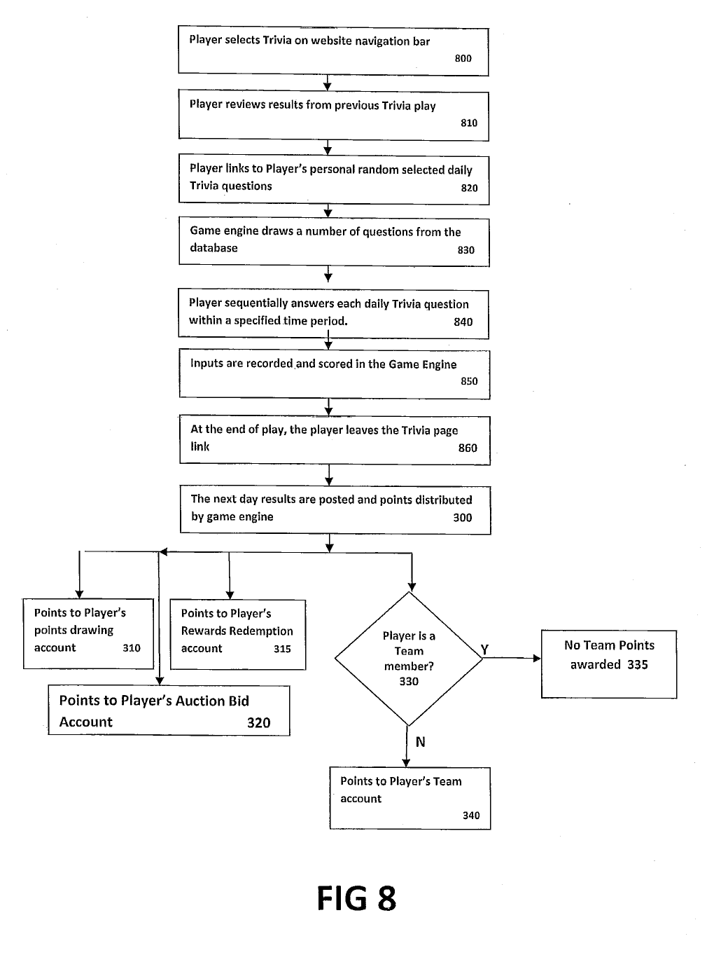

FIG. 8 is a block diagram showing how players participate in the Trivia game. Players are offered Trivia play of a predetermined number of trivia questions once per calendar day. To prevent collusion, the answers and the player's points score are not available until the following calendar day. The player selects the Trivia page 800 from the Web site navigation bar. The initial trivia page 810 shows the results from the player's previous trivia play including the questions offered with the correct answers, the player's selections and the points earned for those selections and possibly the explanations supporting the correct answers. A link from the page 820 takes the player to their individual current day's random trivia questions. The game engine draws a specified number of trivia questions from the data base 830 and the player sequentially answers each question 840 within a specified time period. The time remaining for each question is posted with the question. The player answers the questions presented in sequence and the inputs are recorded and scored in the game engine 850. Questions not answered in time or not answered at all in the sequence are awarded zero points. At the end of play the player leaves the Trivia page link 860. The results are stored until the following day when the results are posted 300 and the points distributed 305 to the player's prize drawing account 310, rewards redemption account 315, player's auction bid account 320 and if a member of a team 330 to the player's team account 340. The following day or later, the player returns to the Web site Trivia page link to review the previous results and set up for the current day's Trivia contest.

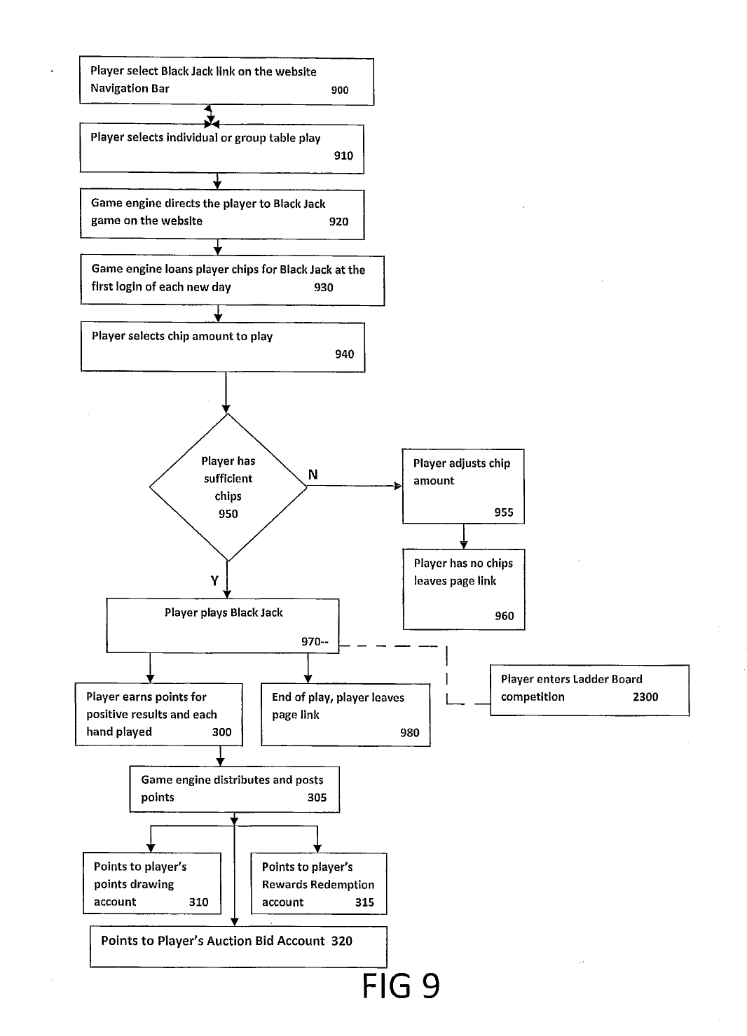

FIG. 9 is a block diagram showing how players participate in the Blackjack card game or similar card games for points. The Blackjack card game runs continuously on the Web site. Players play for a points award and a virtual chips award concurrently. Blackjack play points are awarded for quality of play and the number of hands played according to rules published on the Web site. The player selects the Blackjack card game link on the Web site navigation bar 900 and then selects individual play or table play 910. The player is directed by the game engine to the appropriate game 920. Each day players are issued a predetermined number of virtual chips which are used to score the game 930. That same number of chips is decremented from the player's chip accumulation total at the end of the day. Negative chip balances are zeroed out such that the following day the player begins play with the daily chip issue plus the accumulation of any chips won over the daily issue amount on previous play. For each deal, the player selects the chip amount to bid 940. The game engine determines if the player has sufficient chips to continue play 950. If the player has chips remaining the player can adjust the chip bid 955. If not, the player leaves the page link 960. If the player has sufficient chips the player plays Blackjack 970. The points earned and the player's chip balance from chips either won or lost are tabulated and displayed after each hand. The player earns points for positive game results and each hand played 300. The game engine distributes the player's points 305 to their prize drawing account 310, their rewards redemption account 315 and their auction bid account. At the end of play, the player leaves the Blackjack card game page link 980.

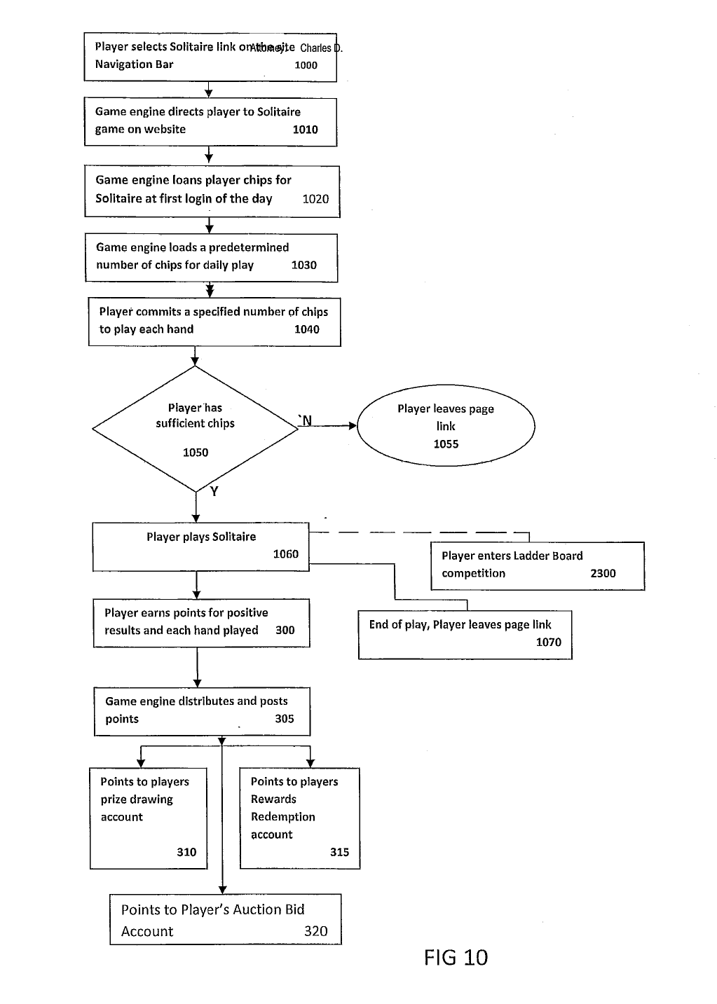

FIG. 10 is a block diagram showing how players participate in the Klondike solitaire game or similar card games for points. The Klondike solitaire game runs continuously on the Web site. Players play for a points award and a virtual chips award simultaneously. Klondike solitaire play points are awarded for quality of play and the number of hands played according to rules published on the Web site. The player selects the Klondike solitaire card game link on the Web site navigation bar 1000. The game engine directs the player to the Solitaire game link on the Web site 1010. The game engine loans the player a predetermined number of chips at first login of the day 1020. The Game engine loads a predetermined number of chips for daily play 1030. The player commits a predetermined number of chips from their chip account balance to play each hand of the game 1040. The game engine determines if the player has sufficient chips to continue play 1050. If not, the player leaves the page link 1055. If the player has sufficient chips the player plays Solitaire 1060. The points earned and the player's chip balance from chips either won or lost are tabulated and displayed during play 300. The game engine distributes the player's points for the hand played and positive results 305 to their prize drawing account 310, their rewards redemption account 315 and their auction bid account 320. At the end of play the player leaves the Klondike solitaire card game page link 1070.

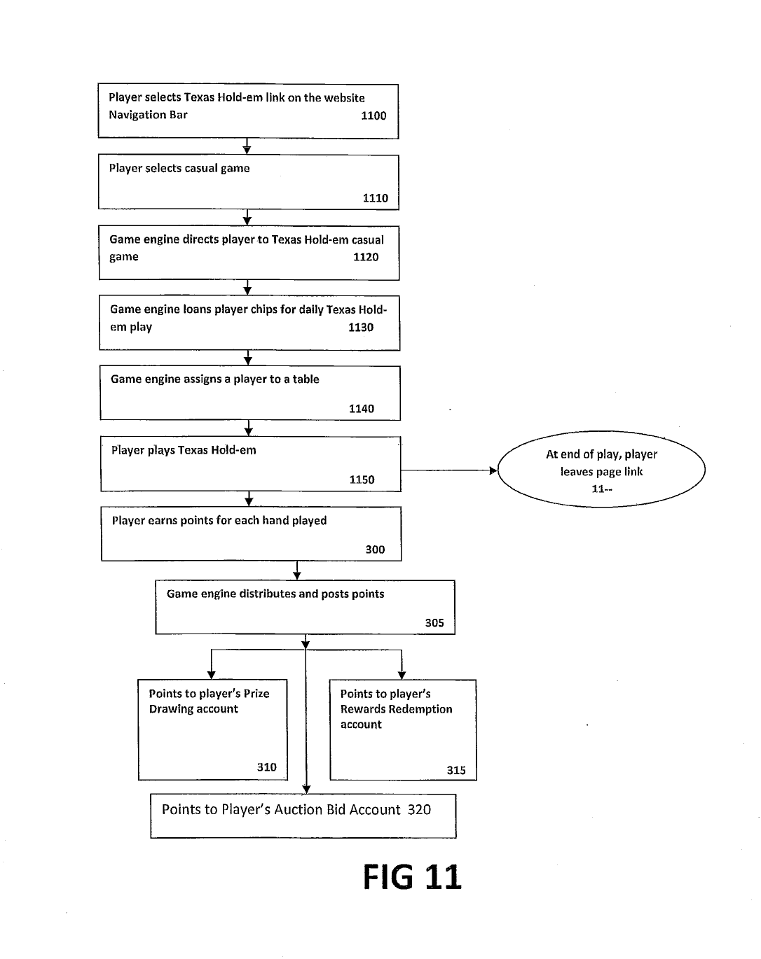

FIG. 11 is a block diagram showing how players participate in the Texas Hold'em card game for points. Texas Hold'em play points are awarded for the number of hands played according to rules published on the Web site. The player selects the Texas Hold'em card game link on the Web site navigation bar 1100. The player selects casual game play 1110. The game engine directs the player to the Texas Hold'em casual game link on the Web site 1120. The game engine loans the player a predetermined number of chips for daily Texas Hold'em play 1130. The game engine determines what card tables are available and displays them on the Web site. The player selects which table to play 1140. Alternately, the game engine randomly assigns the player a card table for play. The player plays Texas Hold'em 1150 against other players and earns points for each hand or deal played 300. The player's points are credited through the Web site's points distribution system 305 to the player's prize drawing account 310, rewards redemption account 315 and auction bid account. At the end of play, the player leaves the page link 1160.

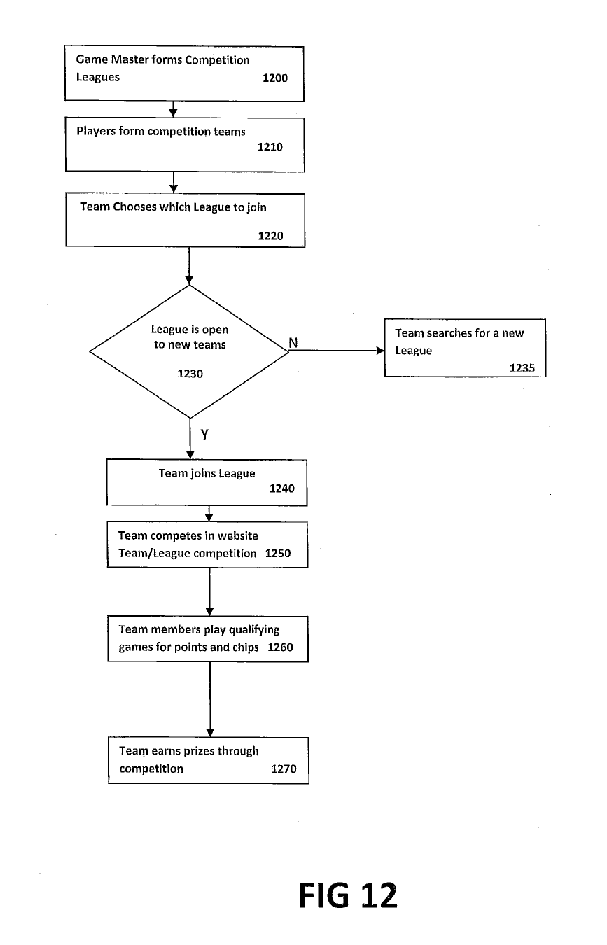

FIG. 12 is a block diagram describing how the Web site leagues and teams are formed and operate for competition points and chips play. The Game master forms leagues by geographical location 1200. Game competition teams are formed 1210 with a specified limit of the number of players that form each team. To achieve competition balance the Game master may place limits on the number of teams that can compose a specific league or leagues at any one time. The team applies to a league they wish to join 1220 without regard to the residency or affiliation status of its members. The game engine determines if the league is open for new teams 1230. If not the team applies to another league 1235. After the team is accepted into a league 1240, the team competes in Web site Team/League competition 1250. Team members play qualifying games 1260 such as Predictions and Trivia for team points and card games for chips. Earned points or chips by team members are credited to the aggregate team score. The team competes in the Web site competitions between leagues and between teams within the leagues. Teams earn prizes through the competitions 1270 based upon team points or for chip scores as race winners in the ladder board card race.

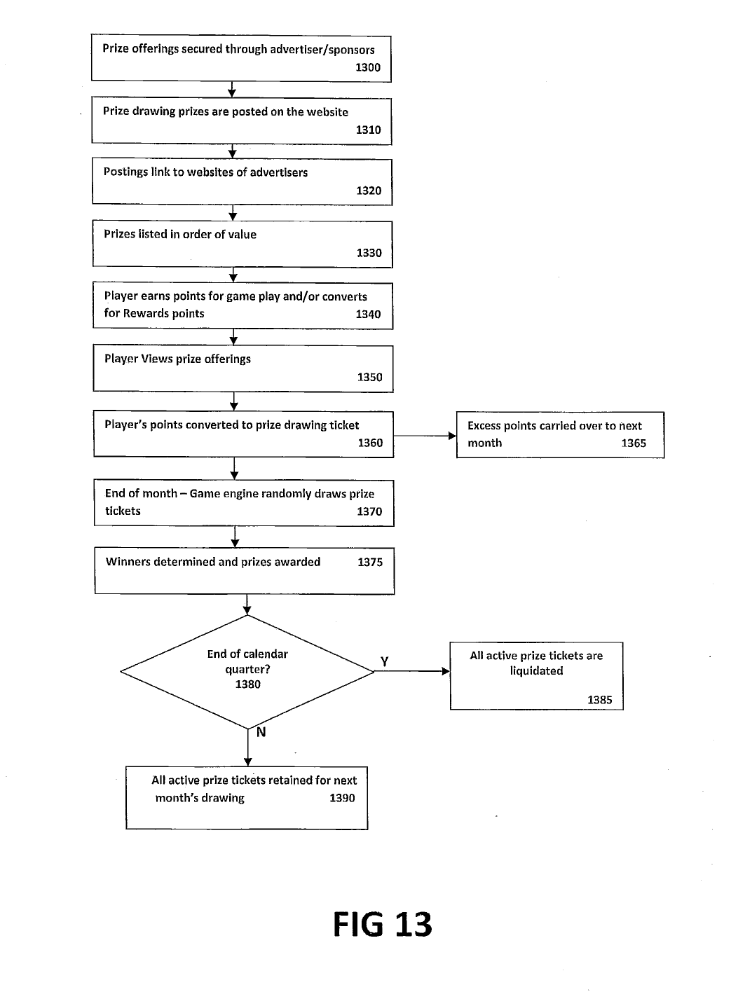

FIG. 13 is a block diagram showing the process flow for the monthly/quarterly Prize Drawing. A current advertiser or a new potential advertiser/sponsor is approached with an offer to become a sponsor for the Web site prize drawing 1300. The prize offerings are posted 1310 on the Web site with links to the sponsor's Web site 1320. The game engine will list the prize offering 1330 sequentially in the order of value with other prize offerings. Alternatively, the game engine may structure prize offerings in blocks based upon valuation and a game engine ad rotator would rotate the ads periodically within each block. The player earns prize drawing points for game play and has the option to convert rewards points for additional prize drawing points 1340. The player views the prize offerings 1350. When the player accumulates a specified number of points in their Prize Drawing Account the game engine automatically converts those points into a prize drawing ticket 1360. Any excess points in the conversion process are carried over month to month and quarter to quarter 1365. At the end of each month the game engine randomly and sequentially selects from the total number of drawing tickets, a number of prize tickets that match the number of prize offerings posted 1370. Prizes are awarded to the recipients in accordance with the Web site's prize award bid system 1375. If the prize drawing occurs at the end of a calendar quarter 1380, all prize drawing tickets are liquidated 1385 after the drawing. If the prize drawing occurs at the end of a month that is not the end of the calendar quarter, all prize drawing tickets including previous winning tickets are retained for subsequent drawings 1390.

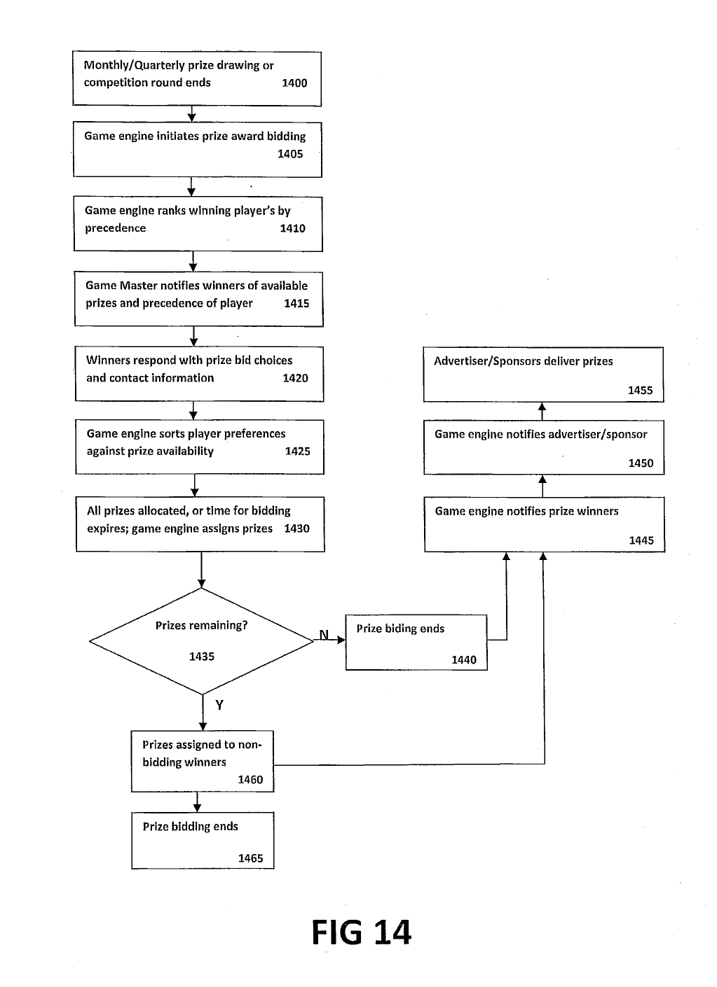

FIG. 14 is a block diagram showing the process flow for the prize award bid system. Bidding begins after a monthly/quarterly prize drawing, team points competition round or ladder board or leader board cycle ends 1400. The game engine initiates the prize award bid system 1405. The game engine ranks all players 1410 in the sequence order in which their winning tickets were randomly drawn or their league/team and individual competition placement in a competition round. The game may notify winners by e-mail 1415, as well as by putting an alert in their browser client when they visit the site, of the sequence bid position of their winning ticket or competition precedence. Winners may then bid on prizes 1420 in the following manner: Winners are presented with the full selection of prizes and requested to select a number of prizes 1425, in the order of their preference, equal to their ticket drawing sequence order position or game competition precedence. For example, the first ticket draw earner or first precedent holder need only choose one prize; the second place only needs to choose two prizes, etc. This bidding process continues until all prizes have been allocated or until the time allotted for bidding expires at which point the game engine prioritizes the bids and assigns the prizes 1430 to the player's highest choice available consistent with the player's bid precedence. The Game Engine determines if there are any prizes remaining 1435. If not, the bidding ends 1440. The game engine notifies all prize winners of the prize they were assigned 1445. The Game Engine notifies the advertiser/sponsor of prize recipient 1450 and the sponsor delivers the prize 1455. In the event that there are winners who have not entered a bid for a prize, the remaining prizes will be assigned to the non-bidding winners 1460 in descending order by stated market value. The prize bidding ends 1465.

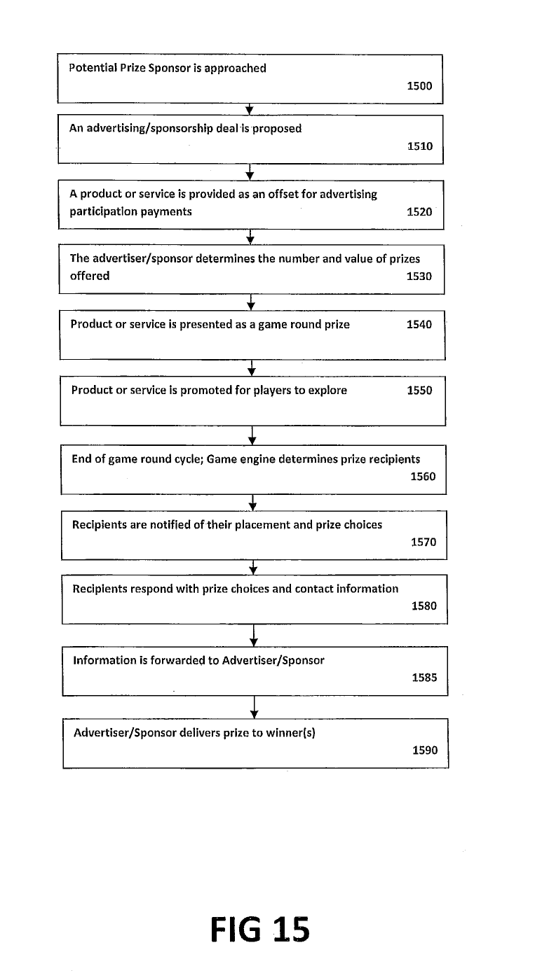

FIG. 15 is a block diagram showing how advertisers/sponsors participate in the game by making their products or services available in a prize drawing or for a competition winning or position placement prize. The process is the same for the monthly/quarterly prize drawing and all game competitions. A current advertiser or a new potential advertiser/sponsor is approached with an offer to become a sponsor 1500. A sponsorship package is proposed 1510 whereby products or services are offered as an offset partial payment for the advertising contract 1520. Services or products such as gift cards, e-cards or merchandise, etc. are determined to be suitable prizes. The advertiser/sponsor determines the number and value of the prize 1530 or prizes being offered. The product or service becomes a game prize 1540 and is featured prominently in various places on the Web site. The prize or reward is strongly promoted, and the player is encouraged to explore both the prize itself and the sponsor 1550 by various means including information on the Web site and advertisement links to the sponsor's Web site. At the end of the game round cycle, the game engine determines the eligible prize recipients 1560. Winners are notified of their placement and their available prize choices 1570. Winners respond with their prize choices and contact information 1580. This information is in turn forwarded to the advertiser/sponsor 1585 committed to supplying the prize. The sponsor delivers the prize 1590 to the player.

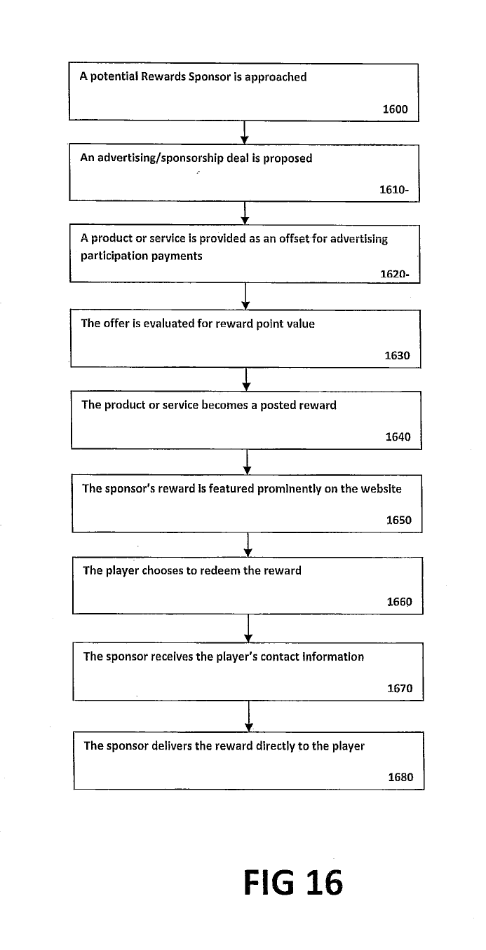

FIG. 16 is a block diagram describing how advertisers/sponsors participate in the games by making their products or services available as a Reward. A current advertiser or a new potential advertiser/sponsor is approached with an offer to become a sponsor 1600. A sponsorship package is proposed 1610 where products or services are offered as a partial payment for the advertising contract 1620. The offer is evaluated for Reward points value 1630. This product or service becomes a posted Reward 1640 and it features prominently in various places on the Web site 1650. The Reward is strongly promoted, and the player is encouraged to explore the Reward itself and the sponsor by various means including information on the Web site and advertisement links to the sponsor's Web site. The player chooses to redeem the Reward 1660. The sponsor receives the player's contact information 1670 and delivers Reward directly to the winner or claimant 1680.

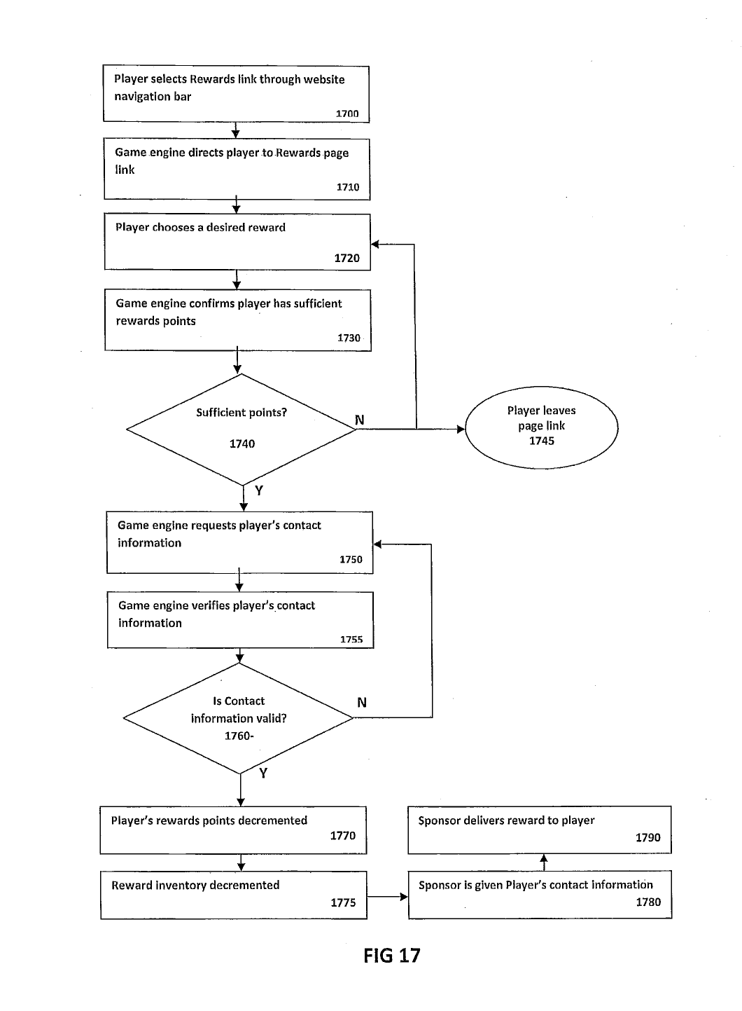

FIG. 17 is a block diagram showing how a player redeems Reward points for a Reward. The player selects the Rewards link from the Web site navigation bar 1700. The game engine directs the player to the Rewards page link 1710. Once on the link the player chooses a desired Reward 1720 from the competing offers. The game engine then confirms that the player has sufficient reward points to redeem for the chosen Reward 1730. If so the player is provided the Reward 1740. If not, the player has the option to select another Reward or leave the page link 1745. The game engine requests the player confirm existing contact information 1750 such as address, and telephone number. The Game Engine verifies the player's contact information 1755. The game engine validates the contact information 1760. The player's Reward points total is decremented 1770. The Reward inventory is decremented 1775. The sponsor is given the player's contact information 1780. The sponsor delivers the Reward to the player 1790.

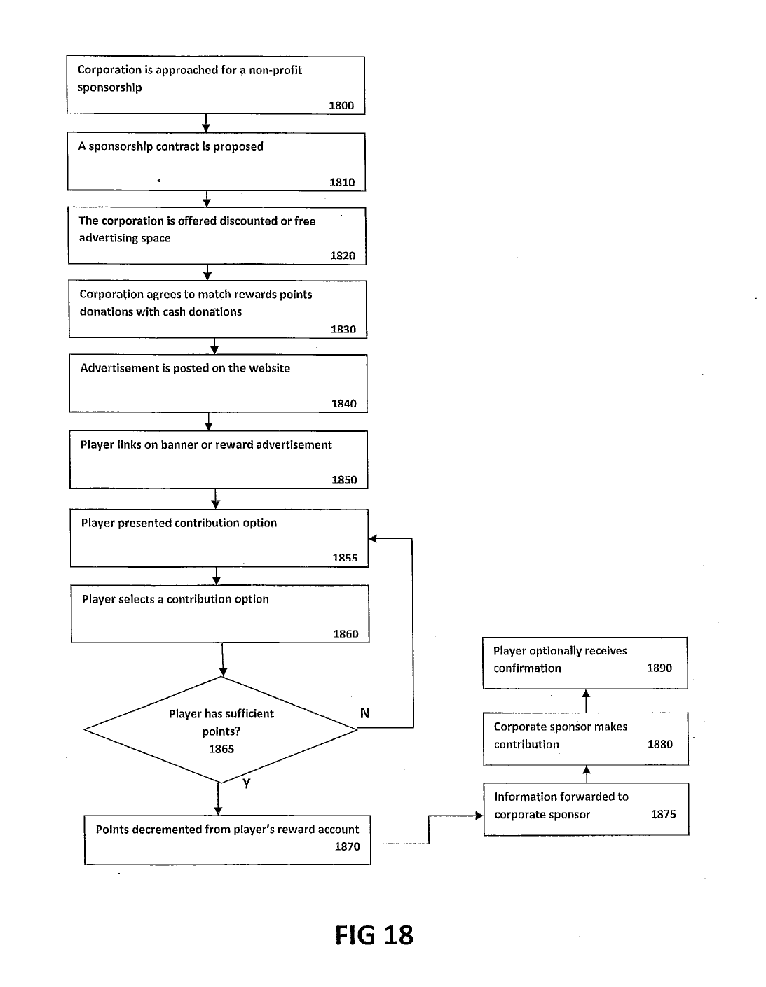

FIG. 18 is a block diagram showing how a corporation might contribute to a sponsored nonprofit organization by redeeming player offered reward points. A current advertiser or a new potential advertiser/sponsor is approached with an offer to conduct a campaign for their sponsored non-profit organization 1800. A sponsorship package contract is proposed 1810 whereby the corporation might receive free or discount banner advertising for the campaign 1820. The corporation offers to match rewards points donations from players with cash donations to the nonprofit 1830. The advertisement is posted on the Web site for the player to view 1840. The player links from the banner advertisement 1850 and the offer to contribute is presented with options as to the amount the player might like to contribute 1855 and the cash equivalent the corporation will contribute for each option. The player elects to make the contribution of their reward points and selects the number of points 1860 they wish to contribute. The game engine then confirms that the player has sufficient reward points 1865 to redeem for the contribution. If not the player has the option of adjusting the offer. The game engine decrements the points from the player's reward redemption account 1870 based upon their selection. The selection information is forwarded on to the corporate sponsor 1875. The corporation makes the appropriate contribution 1880 to the sponsored non-profit organization. The donor has the option to provide their contact information for confirmation 1890 from the sponsoring corporation and the non-profit organization.

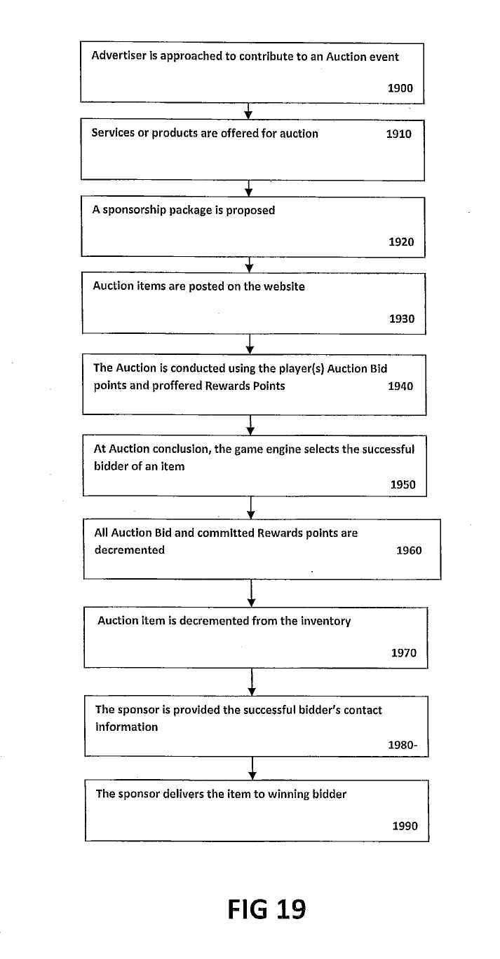

FIG. 19 is a block diagram describing how advertisers/sponsors participate in the game by making their product or service available as an auction event bid item. The Web site will periodically conduct bid auction events, silent auction events or a combination of both for the purpose of infusing a dynamic element into the Web site's marketing campaign and to provide a promotion campaign platform for retailers to introduce new products and liquidate excess inventories and obsolescent products. A current advertiser or a new potential advertiser/sponsor is approached with an offer to become a contributor 1900 to the auction event. Services or products such as gift cards, e-cards, merchandise, etc. are determined to be suitable auction items for the redemption of reward points and are offered for auction 1910. A sponsorship package is proposed 1920. Auction items are posted 1930 on the Web page prior to the auction event itself. At a contributor's request the retail value of an item or service offered may be included in the posting. The game engine will attempt to list the auction ad offerings sequentially in the order of value. Alternatively, the game engine may structure auction ad offerings in blocks based upon valuation and the game engine ad rotator rotates the ad offering periodically within each block. The auction is conducted according to stated auction protocols and rules posted on the Web site using the player's Auction bid points and committed Reward points in a players Reward redemption account 1940. The game engine determines the successful bidder for each auction item 1950. All Auction bid points and committed Rewards points committed in an auction bid are decremented from the players' accounts 1960. The auction item inventory is decremented 1970. The sponsor is given the player's contact information 1980 and the sponsor delivers the item to the player 1990.

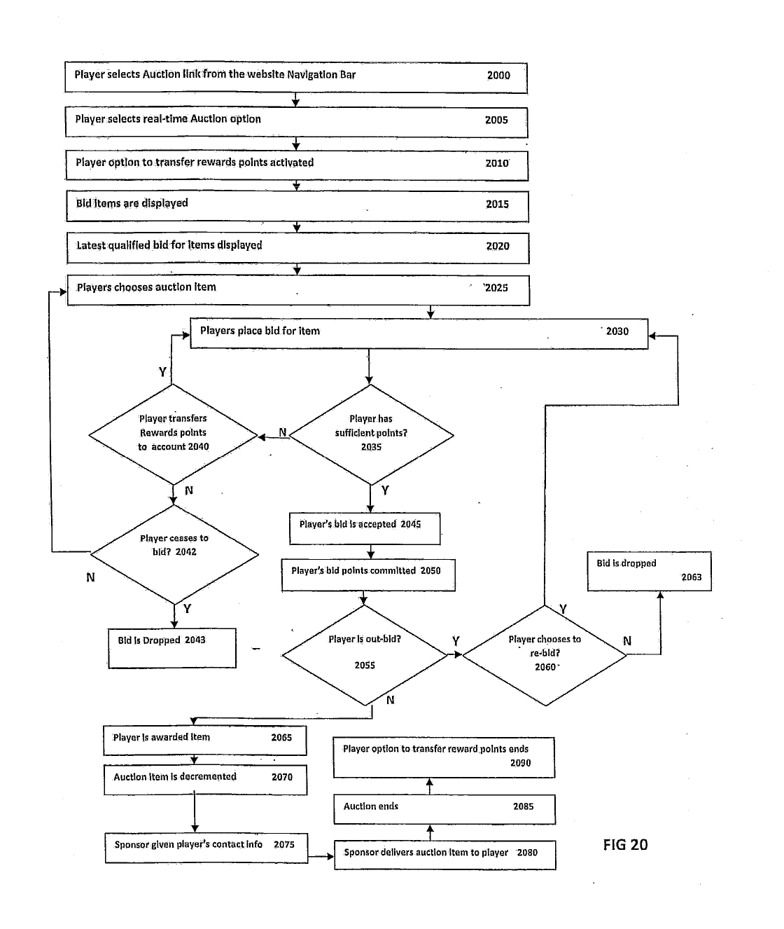

FIG. 20 is a block diagram describing how Web site players participate in a game real-time auction event. The player selects the auction event link from the Web site navigation bar 2000. From that link the player selects the real time auction bid option 2005 and the player is then directed to the appropriate page. The option to transfer Rewards points is activated 2010. The player is presented with the menu of available auction items for bid 2015. The amount of the current reward points bid leader 2020 is displayed for each item. The player selects an auction 2025 item and places a bid for the item 2030. The game engine checks to see if the player has sufficient points for a valid bid 2035. If not, the player has the option of purchasing or transferring additional points from their Rewards account into their Auction Bid account 2040 and rebid 2030 or cease bidding 2042. If the player's bid is accepted 2045 the player's bid points are committed 2050 and cannot be used for any other purpose. If a player is outbid 2055, the player has the option to rebid 2060. If a player is the successful bid winner 2065 for an auction item, they are notified and the auction item is decremented 2070. The sponsor is given the player's contact information 2075 and the sponsor delivers the item to the player 2080. At the end of the auction event 2085, the game engine terminates the option to purchase or transfer rewards points between accounts 2090.

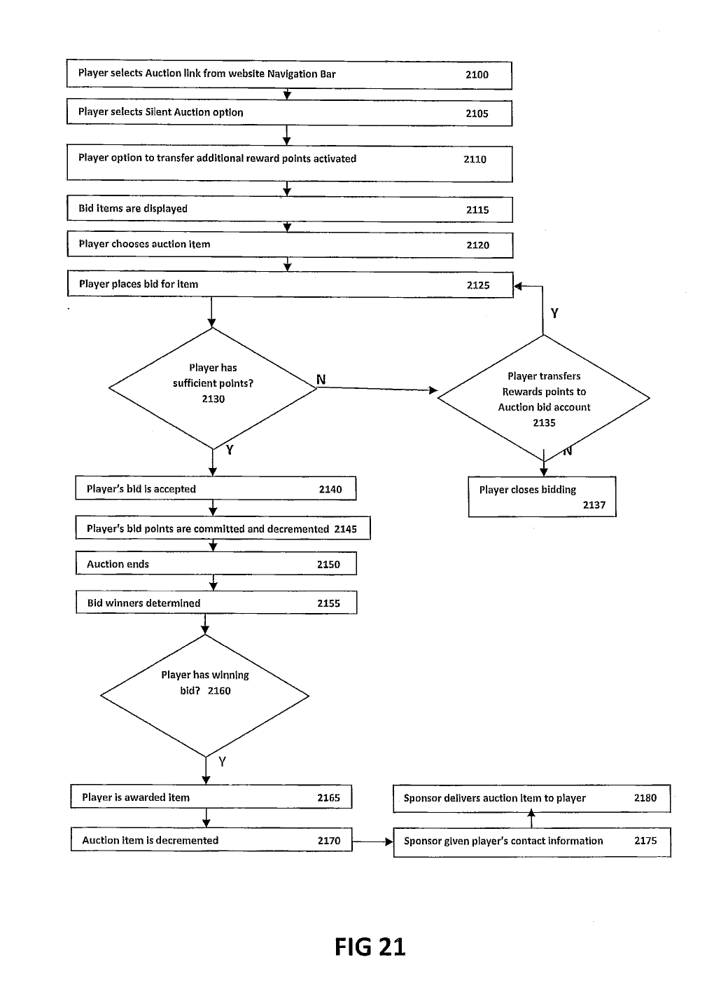

FIG. 21 is a block diagram describing how Web site players participate in a silent game auction event. The player selects the auction event link from the Web site navigation bar 2100. From that link the player selects the silent auction bid option 2105 and the player is then directed to the appropriate page. The option for the player to transfer Rewards points to add to their Auction Bid points is activated 2110. The player is presented with the menu of available auction items available for bid 2115. The player selects an auction item 2120 and bids on the item 2125. The game engine checks to see if the player has sufficient points for a valid bid 2130. If not, the player has the option of purchasing or transferring additional Rewards points into their account 2135 and rebid 2125 or cease bidding 2137. If the player's bid is accepted 2140 the player's bid points are committed and decremented 2145 and cannot be used for any other purpose until the bidding is completed. When the auction ends 2150, the game engine determines the bid winners 2155 for each item. If the player is the successful bidder for an item 2160 the player is awarded the item 2165. The auction item is decremented 2170. The sponsor is given the player's contact information 2175 and delivers the item to the player 2180.

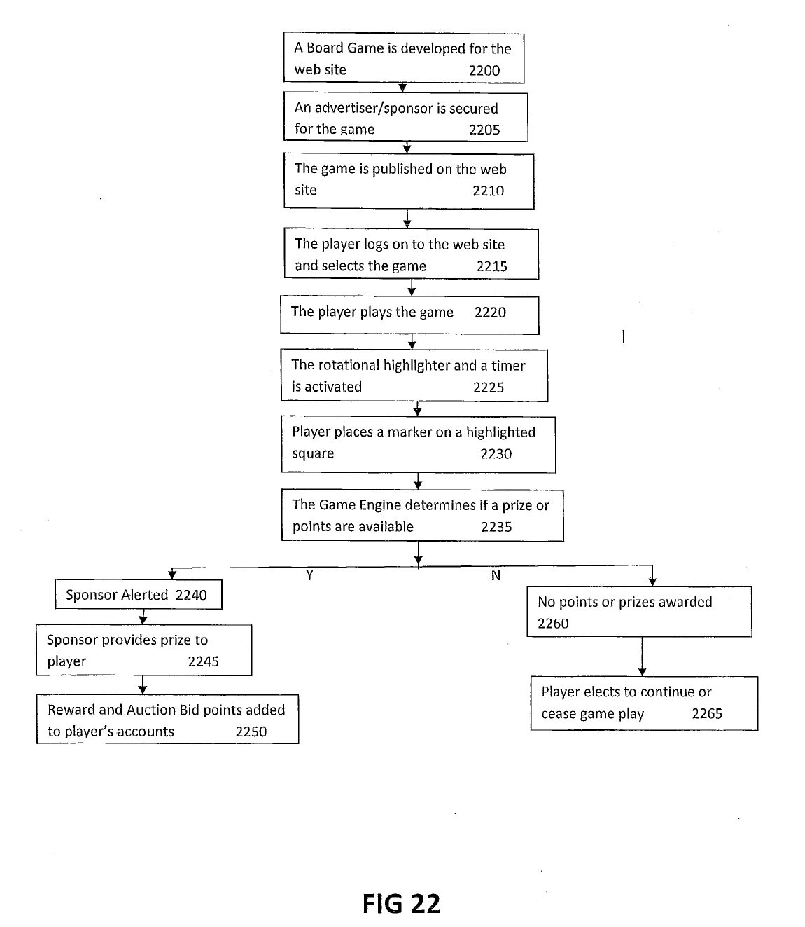

FIG. 22 is a block diagram showing how a board casual game is developed for the Web site 2200 featuring a random rotational high lighter. A current advertiser or new potential advertiser/sponsor is approached to become a sponsor 2205. The game such as Bingo, Sudoku, Crossword Puzzle, etc. is published on the Web site 2210. The game is displayed as a selection choice on the Web site navigation bar of the home page, landing page and other pages as appropriate. The player clicks on the game selection 2215 and is directed to the specific board game Web page. The player plays the game 2220. As soon as the selected game appears on the Web page the game engine software generator activates a rotational highlighter, unseen to the player and a timer 2225. The highlighter moves at random amongst all of the board squares, including non-playable squares. The highlighter remains affixed to each square for a predetermined period of time measured in seconds. If a player places a correct marker, letter or number on a square while the highlighter is on that square 2230, the highlighter becomes visible and the player becomes a recipient of either Rewards plus Auction points, a prize provided by the sponsor or both if the prize and points are available 2235. (No points or prizes are awarded if the rotational high lighter hits a square that has already been filled by the player.) In an alternate version, a game timer is associated with the board game play. A listing of possible game rewards or prizes is posted on the game Web page, listed in decreasing order of value. As the game progresses, at certain timing thresholds prizes are sequentially delisted beginning with the prize with the highest value down to the lowest until all prizes are withdrawn at which point the player plays exclusively for the interest in the game. If a Prize is available, the sponsor is alerted 2240 and the sponsor provides the prize to the player 2245. If points are available, Prize Drawing, Reward and Auction Bid points are added to the player's accounts 2250. If no points or prizes are available, none are awarded 2260. The player elects to continue or cease game play 2265.

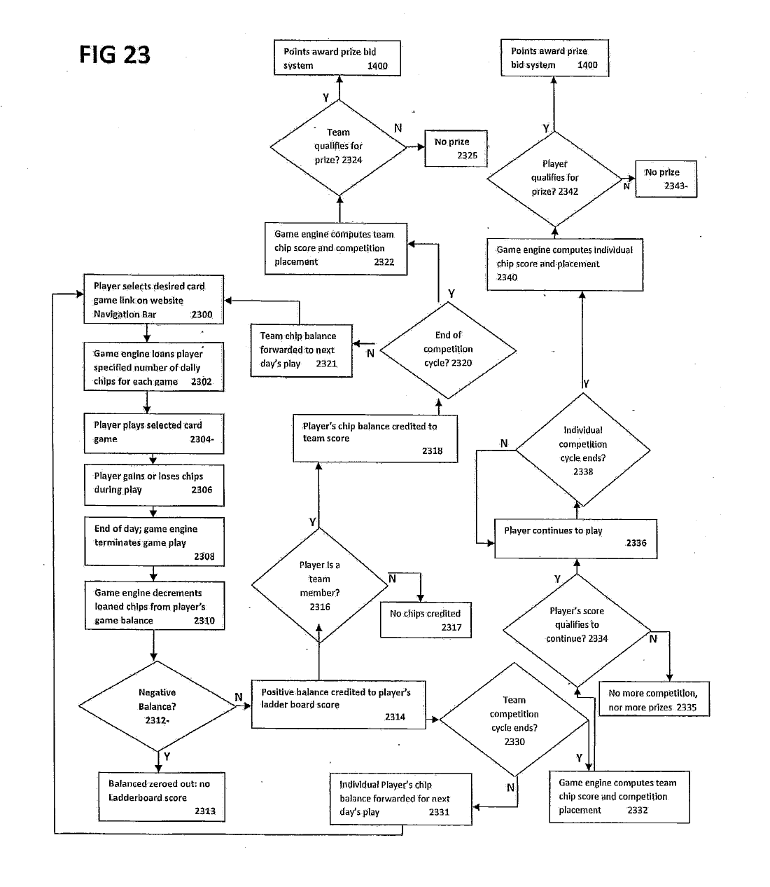

FIG. 23 is a block diagram showing how a player on the Web site participates in the Web site card race ladder board competition. Positive play chip balances allow players to compete concurrently for prize incentives both as individuals and as members of a card race team. Team competitions run month to month and are depicted and conducted as races within the established geographically defined leagues for points play. Individual races run concurrently with the team races plus an additional specified number of days. Virtual chips are used for scoring the player's success at playing the game. The player links to the desired card game 2300 from the Web site navigation bar. At the beginning of each day the game engine loans the player a specified number of chips 2302 for each qualifying card game the player desires to play. The player plays the selected card game 2304 according to established rules specified on the Web site for the game. The player gains or loses chips as the player plays throughout the day on each game 2306. At the end of the day the game engine terminates game play 2308 and subtracts the daily number of chips loaned that day for each game from the player's chip balance 2310. Negative balances 2312 are zeroed out 2313. Positive balances are credited to the player's ladder board score 2314. If the player is a team member 2316 the player's chip balance is credited to their team's aggregate ladder board score 2318 as well. At the end of the day, the game engine also checks to see if the team competition cycle is ended 2320. If not, the player's positive chip balance is carried forward 2321 to the next day's play. The process repeats until the end of the competition cycle for the team competition. At the end of the monthly card race team competition cycle, the game engine computes the team 2322 and individual chip scores 2330 and competition placements 2324 and 2332. If the team qualifies for a prize, the prize is awarded through the prize award bid system 1400. After the team winners and placements for the cycle have been determined, except for the players selected to continue in the individual competition cycle, the chip balances of all other players and teams are zeroed out to begin the next monthly competition cycle 2300. Also at the end of the monthly card race team competition cycle 2330, a specified number of individual players 2332 at the top of the card race ladder board competition continue to play 2334. The selected player continues to compete 2336 for a specified number of days to determine an individual winner and placements. At the end of the competition cycle, the game engine computes the individual chip scores and placements 2340. Players who qualify 2342 for a prize in the individual card race competition receive their prize through the prize award bid system 1400.

The terms and expressions that have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A method of marketing products of others, comprising:
(a) providing a Web server that can be accessed by players over a telecommunications network;
(b) providing a game master component including software loaded on said Web server which allows players who have accessed said Web server to play one or more games and to award points to said players based on said play;
(c) providing game engine software associated with said game master component;
(d) converting each player's award points into a number of drawing tickets, the number of drawing tickets being determined by the amount of that player's points;
(e) soliciting sponsors to provide products to be used as prizes and rewards to be given to players playing said game;
(f) conducting a drawing to determine which players' drawing tickets can be used to obtain said prizes and awards; and
(g) inviting said players to select specific prizes and rewards that are of interest to them, with said players being allowed to select based on the order in which the players' tickets were drawn.

2. A method of marketing products of others, comprising:
(a) providing a Web server that can be accessed by players over a telecommunications network;
(b) providing a game master component including software loaded on said Web server which allows players who have accessed said Web server to play one or more games and to award points to said players based on said play;
(c) providing game engine software associated with said game master component;
(d) soliciting sponsors to provide products to be used as prizes and rewards to be given to players playing said game, each said prize or reward being assigned a value corresponding to a specific number of points; and
(e) inviting players to redeem an appropriate number of points by selecting a desired prize or reward that is of interest to them.

3. A method of marketing products of others, comprising:
(a) providing a Web server that can be accessed by players over a telecommunications network;
(b) providing a game master component including software loaded on said Web server which allows players who have accessed said Web server to play one or more games and to award points to said players based on said play;
(c) providing game engine software programmed to play each of said games;
(d) wherein said games are board games having a plurality of playing spaces;
(e) said game engine software including a highlighter which randomly highlights one of said playing spaces for a defined period of time;
(f) inviting players to place a marker on one or said playing spaces; and
(g) awarding said players points when said marker is placed on a playing space that currently is highlighted.
